(19) United States
(12) Patent Application Publication
(10) Pub. No.: US 2008/0212925 A1
(43) Pub. Date: Sep. 4, 2008

(54) FIBER BRAGG GRATING AND MANUFACTURING METHOD THEREFOR

(75) Inventors: Yoshihiro ARASHITANI, Tokyo (JP); Kazuhiko Kashima, Tokyo (JP); Yasuo Uemura, Tokyo (JP); Mitsunori Okada, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: THE FURUKAWA ELECTRIC CO., LTD., Tokyo (JP)

(21) Appl. No.: 11/964,316

(22) Filed: Dec. 26, 2007

(30) Foreign Application Priority Data
Dec. 27, 2006 (JP) 2006-352068

(51) Int. Cl. G02B 6/34

(52) U.S. Cl. 385/37

(57) ABSTRACT

The present invention provides an optical fiber for a fiber Bragg grating having a high reliability and superior performance. An optical fiber according to the present invention has a glass film containing micro porous bodies formed on the circumference of the optical fiber having a photosensitive core or both of the photosensitive core and a cladding.

### BACKGROUND OF THE INVENTION

1. Field of the Invention

The present invention relates to an optical fiber, and relates to an optical fiber having a grating written therein by changing a refractive index in a predetermined region by irradiating the region with ultraviolet light, and a method for manufacturing these optical fibers, in more detail.

2. Related Background Art

The fiber Bragg grating is a device which imparts a different refractive index to a predetermined region of a core or both of the core and a clad, from the other region, by a step of laterally irradiating the predetermined region in a glass part of an optical fiber with a light having a predetermined wavelength from the side of the optical fiber, and which reflects the light having the specific wavelength among lights passing in the optical fiber. As an optical fiber communication technology has progressed in recent years, a network has been sophisticated, signal frequency has been multiplexed, and consequently a system structure has grown in sophistication. In such a situation, an optical circuit device has increased in importance. One of general structure of the optical circuit device includes a fiber type device. The fiber type device has such advantages as to be a small size, have a low insertion loss, and be easily connected with the optical fiber. Among them, the fiber Bragg grating is an extremely important device and has grown in demand as an effective fiber type device. A light to be used when a grating is written into the optical fiber has a particular wavelength in an ultraviolet range of 240 to 270 μm. The grating is usually written by the step of irradiating the optical fiber with an excimer laser, an argon laser or a carbon dioxide laser.

In general, a glass optical fiber is coated with some material right after the fiber has been formed in the manufacturing process so as to prevent the optical fiber from degrading the strength. In general, there are an optical fiber having the diameter of 0.9 mm coated with a silicon/nylon resin, and an optical fiber having the diameter of 0.25 mm coated with an ultraviolet-curing type urethane acrylate resin. In recent years, the strand having the diameter of 0.25 mm coated with the ultraviolet-curing type resin has become a mainstream because of having a high productivity and being easily accumulated.

By the way, when a fiber Bragg grating is formed, a method is generally adopted which includes removing one part of a coating layer (primary coating layer 4 and secondary coating layer 5) in an middle part of an optical fiber to expose a glass part (glass optical fiber 2), as is shown in FIG. 2. This is because it is occasionally impossible to write the grating by irradiating the optical fiber in a coated state with a laser beam because a resin has an extremely low optical transmittance in a predetermined wavelength region, and also because there is a problem that the resin is burnt to cause deterioration.

A method to be often adopted for removing a coating from the middle part includes a technique of removing one part of the coating so as not to make a blade such as a razor blade directly contact with a glass part, subsequently immersing the part in an organic solvent, and swelling and peeling the coating to remove it.

However, it is difficult to remove only the middle part of a coating layer, and the method may damage the surface of an optical fiber when removing the coating. Then, the method causes a problem of lowering the mechanical strength and consequently lowering the reliability.

In order to solve such a problem, a coating resin has been developed in recent years, which enables a grating to be written by irradiating the optical fiber in a coated state with a laser beam (see Japanese Patent Application Laid-Open No. 2000-227572).

However, when using such a coating as disclosed in Japanese Patent Application Laid-Open No. 2000-227572, it is only an adoptable manufacturing condition to lower an output level of a laser beam in itself, but irradiate the optical fiber with the laser beam for a long period of time instead. The irradiation with the laser beam for a long period of time leads to the decrease of the precision at a grating-written part, consequently may lead to a larger variation of a reflected wavelength and a reflectance, and accordingly is not preferable for achieving a product level which is required by a sophisticated communication system. The irradiation also causes a problem that a coating is damaged by a pulsed laser such as an excimer laser because the excimer laser has a large peak power, and that the breaking strength of the optical fiber is deteriorated.

For this reason, it is the most effective method under present circumstances to remove one part of a once-coated layer of an ultraviolet-curing type resin and write a grating, as is shown in FIG. 2.

Furthermore, an optical fiber to be used for optical parts such as a fiber Bragg grating has been required in recent years to show high reliability. In other words, the fiber has been required to have excellent screening characteristics. The screening is an operation of reversely winding the fiber while applying a tension equivalent to a predetermined elongation of the fiber and cutting a part of the fiber having a low breaking strength beforehand, so as to maintain the reliability of the fiber. The predetermined elongation is referred to as a screening level. Accordingly, the higher is the value, the higher is the tension applied to the fiber, which means that thus screened fiber has a higher degree of reliability. A screening level of an optical fiber to be used for an optical fiber cable is 0.5 to 1%. The screened optical fiber at the level can endure a laying environment sufficiently for a long period of time. The fiber used for optical parts is screened at an equivalent screening level. However, in recent years, the fiber has been demanded to have a higher degree of reliability, specifically, pass a screening level of 2% or higher.

A step of removing one part of a coating on an optical fiber is undesirable from the viewpoint of keeping the screening level high. However, it is practically impossible to write a grating on a glass optical fiber in the bare state, because the glass optical fiber which has not been coated when a fiber has been formed is too fragile and is immediately broken, and it is extremely difficult to hold the fiber when coiling or working the fiber.

### SUMMARY OF THE INVENTION

In order to solve the above described problem, the present invention provides an optical fiber for a fiber Bragg grating having a photosensitive core and a non-photosensitive cladding, or the photosensitive core and a photosensitive cladding coated with a glass film containing an indefinitely large number of micro porous bodies. A method for coating a circumference of a glass optical fiber with the glass film containing the micro porous bodies includes the steps of: passing a glass optical fiber right after having been formed from an optical fiber preform through a sol-gel solution containing the micro porous bodies, and subsequently drying a wet coating film formed on the fiber. The sol-gel solution is converted into the glass film through the drying step, and is fixed on the fiber.

This fiber Bragg grating according to the present invention has a glass film which contains an indefinitely large number of micro porous bodies and is almost transparent to a laser beam in comparison with a conventional technology; and needs an equivalent period of time for writing a grating to the case of removing a coating. Furthermore, the coating of the fiber Bragg grating is not damaged even when the grating is written by using a pulsed laser having a high peak power such as an excimer laser. Moreover, the fiber Bragg grating does not cause a flaw or deterioration on the surface of the glass because of writing a grating on the fiber without passing the fiber in a step of removing the coating, keeps the innate strength of the optical fiber, and accordingly can realize a high breaking strength.

Still furthermore, a fiber Bragg grating according to the present invention can have a resin coating layer formed thereon, for the purpose of improving the handling of the fiber after a grating has been written thereon and protecting the surface of the fiber Bragg grating. Thereby, the fiber Bragg grating can not only facilitate the subsequent step of mounting the fiber Bragg grating onto optical parts or the evaluation of other performances, but also enables the mounting to smaller parts or higher-density mounting.

A preferred material of a resin coating layer for the purpose of protecting the surface of a glass optical fiber is a urethane-acrylate-based ultraviolet-curing type resin, because of having a high curing rate and comparatively easily enabling an optical fiber drawing velocity to be increased. The resin is also preferable for the purpose of inexpensively supplying a large amount of fiber Bragg grating. However, the present invention is not limited to the urethane-acrylate-based ultraviolet-curing type resin, but may employ any resin, as long as the resin material has suitable flexibility and mechanical properties and does not impair the purpose of the present invention. The applicable resin includes, for instance, a thermo-setting resin in consideration of heat resistance, such as a silicone resin or a polyimide resin. It is also acceptable to extrude a polyamide resin such as nylon and coat the fiber with the extruded material similarly in consideration of heat resistance or in consideration of workability in a subsequent step.

These resins can be also applied to an optical fiber having a glass film containing micro porous bodies formed thereon.

A fiber Bragg grating according to the present invention is superior in reliability because of being screened at a high level, and dose not need to remove a coating in a middle part for writing a grating in an optical fiber. Accordingly, an optical fiber having a grating written thereon provided by the present invention can show a high degree of reliability and excellent performance.

### BRIEF DESCRIPTION OF THE DRAWINGS

FIG. 1 is a sectional view illustrating an example of a structure of an optical fiber; and

FIG. 2 is a perspective view illustrating an example of a peeled state in a middle part of a coating layer on an optical fiber for a fiber Bragg grating.

### DESCRIPTION OF THE PREFERRED EMBODIMENTS

A preferable embodiment of the present invention will now be described with reference to the drawings, but the present invention is not limited to the embodiment.

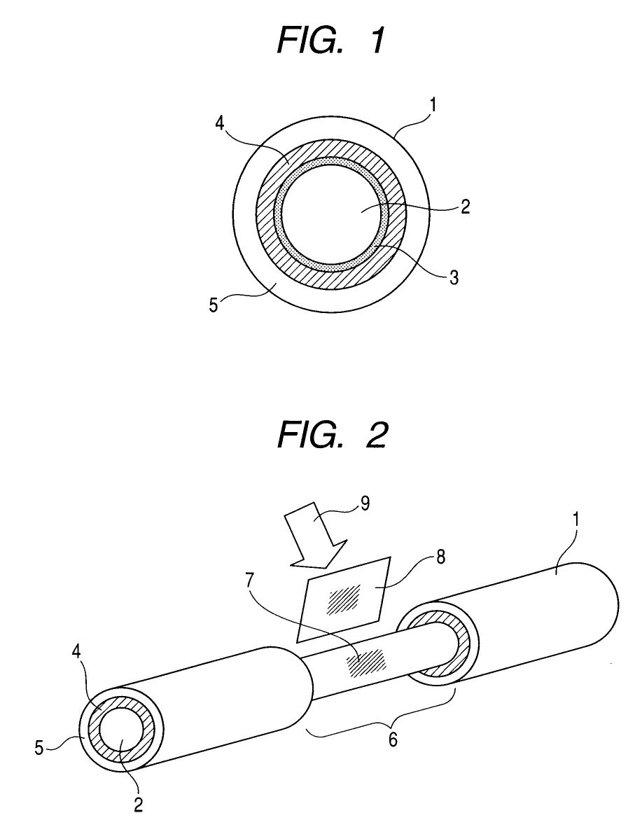

FIG. 1 is a sectional view showing an example of a configuration of a grating according to the present invention. In the figure, an optical fiber 1 is composed of a glass optical fiber 2, and a glass film 3 which is coated on the circumference of the glass optical fiber 2 and contains micro porous bodies. The optical fiber 1 may further include a primary coating layer 4 and a secondary coating layer 5.

A glass film containing an indefinitely large number of micro porous bodies originally aims at inhibiting a glass optical fiber from being broken, by making the micro porous bodies stop the growth of a flaw with a size of a micrometer order formed on the surface of the glass optical fiber by a bending stress applied to the glass optical fiber, and enabling the optical fiber 1 to be wound up around a cylindrical support such as a drum, a bobbin and a reel, and to be stored. However, the glass film itself is made from the same glass material as the surface of the glass optical fiber, and accordingly the glass film is extremely hard, has Young's modulus of several tens of GPa, and directly transmits a stimulus or compressive stress from the outside to the main body of an optical fiber. Then, the optical fiber can cause a transmission loss of an optical signal. Furthermore, the optical fiber 1 is comparatively easily broken by receiving an impact force at a particular part, because of being brittle to an impact force.

As described above, the glass film containing an indefinitely large number of micro porous bodies cannot singly always protect a glass optical fiber effectively from the stimulus or impact force from the outside. For this reason, it is preferable to form the glass film on the surface of the glass optical fiber, wind it up, write the grating on the surface, and further provide a protective layer thereon made from a resin material which is softer and has a high degree of toughness.

Furthermore, it is desirable to provide a soft protective layer having Young's modulus of several tens of MPa or less and preferably less than 10 MPa on the circumference of the glass optical fiber, as a first layer in a resin coating layer, and a hard protective layer having Young's modulus of several GPa or less, and preferably 1 GPa or less further on the circumference as a second layer. The soft protective layer plays a role of absorbing a compressive stress or a stimulus from the outside to apply little load onto the glass optical fiber, but is easily deformed or broken by a mechanical stress such as a tearing force or a pulling force. Accordingly, the hard protective layer is further provided thereon for the purpose of protecting the soft protective layer to keep the performance of the optical fiber for a longer period of time. Specifically, the hard protective layer of the outermost layer plays a role of resisting to the mechanical stimulus or flaw from the outside to the optical fiber, and consequently protects the internal soft protective layer. The soft protective layer of the first layer absorbs these stresses to prevent the stresses from reaching the inner glass optical fiber. Thus, the hard and soft protective layers more surely give the optical fiber superior transmission characteristics and reliability for a long period of time.

A glass optical fiber in context of this specification means a glass fiber formed of a core and a clad, and includes, for instance, a quartz-based glass fiber. The glass optical fiber according to the present invention has a photosensitive core and a non-photosensitive cladding, or the photosensitive core and a photosensitive cladding, as described above. The glass optical fiber according to the present invention can employ a normal SM (single mode) fiber, and particularly preferably employs a glass optical fiber containing hydrogen dissolved in the glass fiber because of having advantages when a grating written thereon.

A glass optical fiber is fundamentally very easily broken. This is because a microscopic flaw existing on the surface of the glass optical fiber grows into a crack and expands. As a countermeasure, a glass optical fiber according to the present invention has a glass film containing the micro porous bodies coated on its circumference, and the micro porous bodies are considered to prevent a crack from growing to show the effect of preventing the growth of the crack. In other words, the glass optical fiber according to the present invention is hardly broken compared to a normal glass optical fiber.

A fiber Bragg grating according to the present invention is prepared by the steps of: passing the glass optical fiber right after having been formed from an optical fiber preform through a sol-gel solution containing micro porous bodies, and subsequently drying a wet coating film formed on the fiber. The sol-gel solution is converted into a glass film through the drying step, and is fixed on the fiber. The sol-gel solution has the same glass composition as in a quartz glass of the glass optical fiber, so that both compositions are extremely conformable, and the formed glass film is substantially integrated with the glass optical fiber. Accordingly, it is possible to directly write a grating in the optical fiber on which the glass film containing the micro porous bodies has been formed, without removing the glass film.

As described above, an optical fiber for a fiber Bragg grating according to the present invention has a suitable bending strength, is tougher than a glass optical fiber, and accordingly can be handled in the same way as that for a resin coated fiber. In addition, it is possible to directly write a grating on the optical fiber without needing to remove the glass film.

When the grating is written, a predetermined region is irradiated with a light having a predetermined wavelength through a predetermined pattern from the side of the optical fiber. Thereby, drawn regions 7 are formed on a glass optical fiber 2 as a fiber Bragg grating, which consist of a stripe, have different refractive index from each other and form refractive index distribution, as is shown in FIG. 2.

Examples of light usable for forming the grating include ultraviolet light having wavelengths of 240 nm to 270 nm, which is output from an excimer laser, an argon laser and a carbon dioxide laser. In addition, a double beam interference or phase mask method can be used for exposing a pattern to write the grating. Furthermore, the grating may be a uniform grating having the regions 7 periodically arranged at a constant interval or may be a chirped grating having the regions 7 periodicity varied in a longitudinal direction of an optical fiber strand 1.

### EXAMPLES

The present invention will now be described in more detail based on examples as embodiment according to the present invention below, but the present invention is not limited to those examples.

A super heat-resistant silica coat fiber (a product made by Totoku Electric Co., Ltd.) was used as an optical fiber for a fiber Bragg grating, which composes examples according to the present invention. Exemplified Example 1 is a fiber Bragg grating prepared by the steps of: preparing an optical fiber which has such optical properties and a size as shown in Table 1, and has a glass film containing micro porous bodies formed thereon through the above described steps; and writing a grating thereon. Exemplified Example 2 is a fiber Bragg grating which was prepared by the step of forming a coating layer of a urethane-acrylate-based ultraviolet-curing type resin further on the previous fiber Bragg grating and had an outside diameter of 0.25 mm.

Comparative examples employed an SM fiber (product name of AllWave Fiber made by Furukawa Electric Co., Ltd.) and a polyimide coat SM fiber (product name of ClearLite Poly 1310-21 made by OFS Corporation (United States)). Respective optical properties and sizes are shown in Table 1.

Fiber samples exemplified in examples and comparative examples were tested through testing methods described below.

(1) Evaluation for Performance of Optical Fiber having Grating Written Thereon

A grating was written on examples and comparative examples by using an ultraviolet laser of 248 nm based on a Kr-F excimer laser of a light source and a phase mask method. Table 2 shows the result of having measured the power (W) of the excimer laser and an irradiation period of time (m), which are needed for forming a grating with a reflectance of 4% on each optical fiber having a different coating from the others shown in Table 1. Table 2 also shows the result of having measured a standard deviation for a mean value of a reflectance of a light having the wavelength of 980 nm and the accuracy (nm) of the wavelength of the reflected light, for evaluating the accuracy of the grating written on the optical fiber in the writing step. Table 2 further shows the result of having visually inspected the appearance of a portion (about 1 mm) into which the grating was written, and having evaluated the case of showing adequate appearance without change as ◯ and the case of showing a burnt or a color change on the surface as ×. For each of examples 1 to 2 and comparative examples 1 to 4, 50 samples were prepared. The grating was written to each of the 50 samples. The mean values and standard deviations in the 50 samples for each of examples and comparative examples are shown in Table 2.

### (2) Evaluation for Screening Characteristics

A grating was written as was described in the above item (1), 10 optical fibers of each example and comparative example were subjected to a 2% screening test. The screening test was repeated on 5 optical fibers having the grating written thereon, and the number of broken fibers during the screening test was compared. The results are shown in Table 2.

### (3) Evaluation of Breaking Strength

Breaking strength was measured on 30 optical fibers having a grating written therein of each example and comparative example on a condition of a tension speed of 50 mm/min. A film in each middle part of Comparative examples 1 and 3 was further peeled off in order to evaluate the breaking strength after the film has been peeled off, and a grating was written on the optical fiber samples having the film in the middle part peeled off therefrom (comparative examples 2 and 4). Then, the breaking strength was measured on the optical fiber samples. The mean values and standard deviations of the measurement results are shown in Table 2.

Here, a preferred example of a method of peeling a film from a middle part will be described below, which was adopted when preparing comparative examples 2 and 4.

Cut a coating in a section at which the coating is to be removed in both ends of an optical fiber strand, in the circumferential direction of the fiber, by using a commercially available fiber stripper (Micro-Strip, Klein Tools, Inc.: with inner diameter of blade of 152 μm). Subsequently, tilt the optical fiber at an angle of 50 degrees with respect to the longitudinal direction of the fiber, and moves the optical fiber between two blades placed at a space of 155 μm vertically. At this time, place the fiber in the center of the space between the two blades so that the blades may not directly contact a glass part, and remove the coating in the section at which the coating is to be removed, vertically in the longitudinal direction, to expose a glass optical fiber (glass part). Then, soak the section at which the coating is to be removed into acetone to which an ultrasonic wave is applied. Finally, pick up the coating resin which is not yet cut in removed ends, with a pair of tweezers.

The reason why the blades are kept at a space of 155 μm in this method is because the blades do not directly contact glass. Because the upper and lower blades are placed so as to tilt at 50 degrees with respect to the coating layer in the middle part of the fiber, the leading edge of the blade, which contacts the coating layer, not merely cuts the resin, but also picks up and pulls the resin and simultaneously cuts the resin. At this time, the blades exert a pulling force on the resin, so that if an interface between glass and a primer coating layer has a small adhesive force, the coating layer is peeled off from the interface, the glass is exposed, and the resin was cut and removed. When the glass was exposed, acetone easily infiltrates into the interface between the glass and the primer coating layer, and the coating layer in the middle part can be completely removed.

The size and transmission characteristics of the prepared optical fiber samples are shown in Table 1, and the test results are shown in Table 2.

TABLE 1

| | | | | Peeling | | | |
|---|---|---|---|---|---|---|---|
| | | | | of | | Outside | |
| | | | | coating | Cladding | diameter | Transmission |
| | | Optical | | in middle | diameter | of fiber | loss @ 1,310 nm |
| | | fiber | Coating | part | μm | μm | dB/km |
| Ex. | 1 | Silica coat | Glass film | — | 125 | 126.3 | 0.52 |
| | | fiber | | | | | |
| | 2 | Silica coat | Glass film + | — | 125 | 250.3 | 0.52 |
| | | fiber | ultraviolet-curing | | | | |
| | | | type resin | | | | |
| Comp. | 1 | AllWave | Ultraviolet- | Not | 125 | 245 | 0.32 |
| Ex. | | Fiber | curing type | conducted | | | |
| | | | resin | | | | |
| | 2 | AllWave | Ultraviolet- | Conducted | 125 | 125 | 0.32 |
| | | Fiber | curing type | | | (coating- | |
| | | | resin | | | peeled | |
| | | | | | | section) | |
| | 3 | ClearLite | Polyimide | Not | 125 | 155 | 0.70 |
| | | | resin | conducted | | | |
| | 4 | ClearLite | Polyimide | Conducted | 125 | 125 | 0.70 |
| | | | resin | | | (coating- | |
| | | | | | | peeled | |
| | | | | | | section) | |

TABLE 2

| | | Process of writing grating | | | | | | Breaking | |
|---|---|---|---|---|---|---|---|---|---|
| | | | Irradiation | Standard | Accuracy | | Number of | strength | |
| | | Power of | period of | deviation of | of | | broken | Mean | |
| | | laser | time | reflective | wavelength | | fibers by | value | Standard |
| | | W | min. | index | Nm | Appearance | screening | GPa | deviation |
| Ex. | 1 | 8 | 2 | 0.15 | ±0.05 | ◯ | 0/10 | 6.53 | 0.12 |
| | 2 | 8 | 2 | 0.14 | ±0.05 | — | 0/10 | 6.49 | 0.11 |
| Comp. | 1 | 0.2 | 60 | 2.6 | ±0.32 | X | 0/10 | 4.31 | 1.92 |
| Ex. | 2 | 8 | 2 | 0.14 | ±0.05 | — | 3/10 | 3.17 | 1.81 |
| | 3 | 1 | 30 | 1.9 | ±0.22 | X | 0/10 | 4.98 | 1.50 |
| | 4 | 8 | 2 | 0.16 | ±0.05 | — | 4/10 | 3.03 | 1.63 |

As is described above, Examples 1 and 2 show preferable results in any characteristics. On the other hand, Comparative examples 1 and 3 show a defect in appearance and a slightly lowered breaking strength as well. This is because the coating was exposed to an excimer laser for a long period of time and consequently the mechanical strength of the coating was lowered. Furthermore, Comparative example 2 and 4 show a conspicuously lowered breaking strength due to an operation of peeling a coating in the middle part. This is because a part of the glass of the optical fiber was damaged due to the step of peeling the coating.

Thus, the present invention can provide a fiber Bragg grating having a high reliability and superior performance.

This application claims priority from Japanese Patent Application No. 2006-352068 filed Dec. 27, 2006, which are hereby incorporated by reference herein.

What is claimed is:

1. A fiber Bragg grating comprising
a photosensitive core,
a cladding, and
a glass film which is formed on the circumference of the cladding and includes a micro porous body, wherein
the core or both of the core and the cladding has a grating written thereon.

2. The fiber Bragg grating according to claim 1, wherein the grating is written by a step of laterally irradiating the side of the optical fiber with a light having a predetermined wavelength to change a refractive index in a predetermined region of the core or both of the core and the cladding.

3. The fiber Bragg grating according to claim 1, further comprising at least one resin coating layer which is formed on the circumference of the glass film and has mechanical properties different from those of the glass film.

4. A method for manufacturing a fiber Bragg grating comprising the steps of:
drawing a glass optical fiber including a photosensitive core and a cladding, from an optical fiber preform;
passing the drawn glass optical fiber through a sol-gel solution containing a micro porous body;
forming a glass film containing the micro porous body on the circumference of the glass optical fiber by drying the film of the sol-gel solution applied onto the glass optical fiber; and
writing a grating in a predetermined region of the core or both of the core and the cladding, by laterally irradiating the side of the glass optical fiber having the glass film formed thereon, with a light having a predetermined wavelength to change a refractive index in the predetermined region.

5. The method for manufacturing the fiber Bragg grating according to claim 4, further comprising the step of forming at least one resin coating layer on the circumference of the glass film having mechanical properties different from those of the glass film.
